(19) United States
(12) Patent Application Publication
(10) Pub. No.: US 2005/0218561 A1
(43) Pub. Date: Oct. 6, 2005

(54) Silcone based scent media

(76) Inventors: Keith Watson, Huntsville, AL (US); Marvin Fourroux, Huntsville, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 10/817,073

(22) Filed: Apr. 2, 2004

(51) Int. Cl. B29C 35/00

(52) U.S. Cl. 264/319

(57) ABSTRACT

A scent media that uses silicone or other elastomeric material as a base component has been developed. The method for making a scented media, includes forming an elastomeric material and then adding a scented material to the elastomeric material to form the scented media. Finally the scented media is cured for a specified time based on the desired characteristics for the media.

### BACKGROUND OF INVENTION

1. Field of the Invention

The invention relates generally to scent-containing media. More specifically, the present invention relates to silicone based scent media.

2. Background Art

Scented materials are widely used to as deodorants and air fresheners. They are also commonly used by hunters and fishermen as attractants for fish and game or to mask any odors that may frighten off wild game. Examples of such materials include: a scented gel; a topical spray; or a liquid that is applied to a holding media such as felt. Each of these examples is an effective method of dispersing the scent. However, the scent typically is not effective for very long. Evaporation, heat, rain, and other factors may work to rapidly reduce the strength and duration of the scent from the media. Consequently, a scented silicone media with a long lasting, embedded scent is needed.

### SUMMARY OF INVENTION

In some aspects, the invention relates to a method for making a scented media, comprising: forming an elastomeric material; adding a scented material to the elastomeric material to form the scented media; and curing the scented media.

In other aspects, the invention relates to a method for making a scented media, comprising: step for forming an elastomeric material; step for adding a scented material to the elastomeric material to form the scented media; and step for curing the scented media.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a flow chart of the steps for making a scent media in accordance with one embodiment of the present invention.

### DETAILED DESCRIPTION

A scented silicone media with a long lasting, embedded scent has been developed. The scented media may be used by hunters as an attractant for game or alternatively as a mechanism for masking the scent of the hunter. Fishermen may also use the media as a supplemental attractant for a lure that is formed either partially or wholly out of the media. Additionally, other types of deodorant scents may be used in the scented media for applications in homes, vehicles, commercial establishments, etc.

The scented media has a base material of polydimethlysiloxane which is commonly referred to as “silicone”. The base material, typically in the form of a liquid or gel, is mixed with a scented material such as a liquid concentrate. The final scented media is then allowed to cure or set in the desired form. In some embodiments, the scented media is pored into a mold in order be cured into a desired shape. For example, hunting scents may be cast in the form of leaves for the purpose of camouflage. Also, a scented fishing lure may be cast in the form of soft plastic bait while deodorant scents may be cast in the form of decorations such as flowers, etc.

In other embodiments, other suitable elastomers such as polyurethane could be used as a base material. Polyurethane elastomers are one member of a large family of elastic polymers called rubber. Polyurethane may be a liquid that can be molded into any shape or size. It is formed by reacting a polyol (an alcohol with more than two reactive hydroxyl groups per molecule) with a diisocyanate or a polymeric isocyanate in the presence of suitable catalysts and additives. The chemical formula for polyurethane is: C₃H₈N₂O. A wide variety of diisocyanates and polyols can be used to produce polyurethane in alternative embodiments. It should be understood that the term “polyurethane” includes a wide variety of thermoplastic polyurethane elastomers that are manufactured differently and may have different performance characteristics.

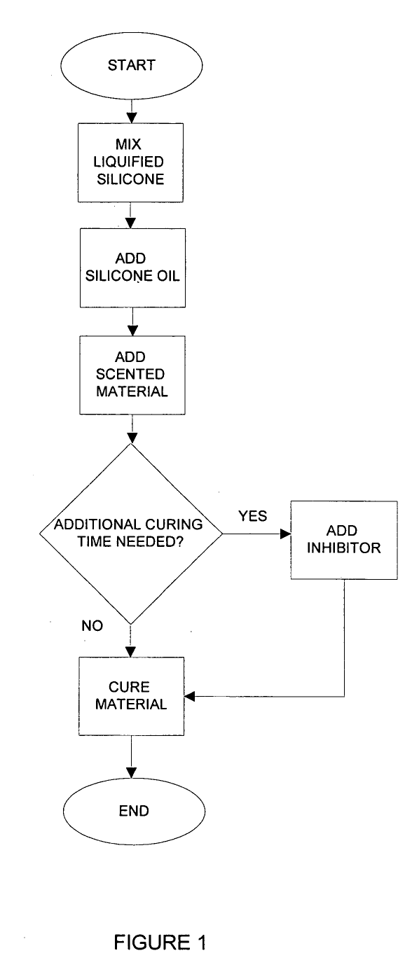

FIG. 1 shows a flow chart of the steps for making a scent media in accordance with one embodiment of the present invention. The first step is making a liquid silicone solution. This can be done from materials that are well known to one of ordinary skill in the art. Typically, the liquid silicone is form by mixing several liquid components. Next, silicone oil is added to the mixture. In this embodiment, the amount of silicone oil that is added is 10% (by weight) of the liquid silicone. Next, the scented material is added. This material may be a liquid concentrate of the desired scent. The amount of scented material that is added is 5-40% (by volume) of the mixture. For hunting scent media, 15% (by volume) of a liquid concentrate has yielded good results.

Now, the material is ready to cure. Typically, the material may cure in 15-30 minutes at 180° F. or in 24 hours at room temperature. However, the material may still be pliable and capable of being molded for 20 minutes after mixing the last ingredients. If additional time is needed before curing the mixture, an inhibitor may be added to length the total cure time.

While the example described in FIG. 1 uses silicone, it should be understood that other base elastomeric materials such as polyurethane could be used instead of silicone. The mixtures and recipes of other materials would vary according to their specific properties. It should be understood that a wide variety of scented materials could be used for attractants or masking scents in both fish and game applications. This is also true for deodorants used in consumer applications as well.

The advantage of the present invention is that the scented media holds the scent for a great length of time. The scent that is mixed with the media is resistant to evaporation. Additionally, the scent is resistant to dilution from exposure to weather conditions such as rain or snow. Testing of the scented media as disclosed has shown no perceptible loss of scent intensity after one year of use under varying conditions.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. A method for making a scented media, comprising:
forming an elastomeric material;
adding a scented material to the elastomeric material to form the scented media; and
curing the scented media.

2. The method of claim 1, where the elastomeric material is polyurethane.

3. The method of claim 1, where the elastomeric material is liquid silicone.

4. The method of claim 3, further comprising:
adding silicone oil to the liquid silicone.

5. The method of claim 3, further comprising:
adding a curing inhibitor to the scented media to lengthen time required for curing the scented media.

6. The method of claim 3, where the scented material is a liquid concentrate.

7. The method of claim 6, where the amount of scented material added to the elastomeric material is between 5-40% of the volume of the elastomeric material.

8. The method of claim 6, where the amount of scented material added to the elastomeric material is 15% of the volume of the elastomeric material.

9. The method of claim 1, where the scented media is cured in a mold.

10. The method of claim 1, where the scented media is a deodorant.

11. The method of claim 1, where the scented media is used as a fish attractant.

12. The method of claim 1, where the scented media is used as a game attractant.

13. The method of claim 1, where the scented media is used to mask a hunter's scent.

14. A method for making a scented media, comprising:
step for forming an elastomeric material;
step for adding a scented material to the elastomeric material to form the scented media; and
step for curing the scented media.
